(19) United States
(12) Patent Application Publication
(10) Pub. No.: US 2025/0170792 A1
(43) Pub. Date: May 29, 2025

(54) METHOD OF FABRICATING AT LEAST ONE OPTICAL ELEMENT

(71) Applicant: TRINAMIX GMBH, Ludwigshafen Am Rhein (DE)

(72) Inventors: Moritz LAUBSCHER, Ludwigshafen am Rhein (DE); Henning ZIMMERMANN, Ludwigshafen am Rhein (DE)

(21) Appl. No.: 18/842,438

(22) PCT Filed: Mar. 27, 2023
(86) PCT No.: PCT/EP23/57782

§ 371 Date: Aug. 29, 2024

(30) Foreign Application Priority Data
Mar. 28, 2022 (EP) 22164747.2

(51) Int. Cl. B29D 11/00; B29C 45/00; B29C 45/02; B29C 45/14; B29L 11/00

(52) U.S. Cl. CPC B29D 11/00865; B29C 45/0055; B29C 45/02; B29C 45/14336; B29D 11/0073; B29L 2011/00

(57) ABSTRACT

Described herein is a method of fabricating at least one optical element, specifically at least one optical element for a spectrometer device. The method includes: i. at least one preparation step, where the preparation step includes providing at least one substrate having at least one first surface and at least one second surface, where the second surface is located opposite with respect to the first surface; ii. at least one deposition step, where the deposition step includes applying at least one first layer to the first surface of the substrate, where the first layer includes at least one of an optical filter and an anti-reflection coating and iii. at least one molding step, where the molding step includes molding at least one optical lens onto the first layer. Also described herein is a system for fabricating at least one optical element.

### TECHNICAL FIELD

The present invention refers to a method of fabricating at least one optical element, to a system for fabricating at least one optical element and to the optical element. The optical element may, in particular, be used for spectrometer devices configured for optical investigation or monitoring of objects, specifically with regard to determining transmissivity, absorption, emission and/or reflectance of objects. Such devices can be employed in various areas of daily life, gaming, traffic technology, mapping of spaces, production technology, security technology, medical technology or in the sciences. However, other fields of application are also feasible.

### BACKGROUND ART

In general, spectrometer devices are known to collect information on the spectral light composition from an object, when irradiating, reflecting and/or absorbing light. Thus, spectrometer devices may comprise several optical components for processing light, such as lenses, filters, gratings, prisms, mirrors, optical waveguides, polarizers or the like. In many applications, spectrometer devices use combinations of two or more of such optical components. As an example, a combination of lenses and filters may frequently be used requiring the assembly of separate elements. The assembly may, generally, comprise a pick-and-place mounting technique. The assembled components may be glued onto each other and mounted onto a bracket or the like. Thus, in general, the assembly of combined optical components may require multiple processing steps leading to high assembly costs and giving rise to possible manufacturing defects.

WO 2012/046826 A1 discloses a black polymerizable composition having an alkali developer resistance, a wafer level lens, and the like. The black polymerizable composition includes at least: a black material; a polymerization initiator; a polymerizable compound; and an alkali-soluble binder polymer having a weight average molecular weight of at least 30,000 and a polymerizable group at a side chain thereof.

US 2021/0394470 A1 discloses method including: providing a substrate, in which a first surface of the substrate includes at least one optical element module region defining an area in which multiple optical elements are to be disposed; forming, for each optical element module region on the first surface of the substrate, a corresponding reflow waste channel in the first surface of the substrate and around a perimeter of the optical element module region; providing a first optical element mold, in which a surface of the first optical element mold includes multiple first cavities, each first cavity defining a shape of a corresponding optical element of the multiple optical elements; providing resin globules between the surface of the optical element mold and the first surface of the substrate; and compressing the first optical element mold to the first surface of the substrate so that the resin fills the multiple first cavities, and so that excess resin flows into the reflow waste channel.

US 2016/0025932 A1 discloses an integrated optical coupling device including a substrate, a coating layer disposed on the substrate, and a prism disposed on the coating layer. The prism may include a first surface and a second surface. The integrated optical coupling device may also include a first lens disposed on the first surface of the prism, a second lens disposed on the second surface of the prism, and an anti-reflection coating layer disposed on the first lens and the second lens.

### PROBLEM TO BE SOLVED

It is therefore desirable to provide methods and devices which at least partially address above-mentioned technical challenges. Specifically, methods and systems shall be proposed which provide a high volume, scalable and cost-effective process for fabricating optical elements.

### SUMMARY

This problem is addressed by a method of fabricating at least one optical element, by a system for fabricating at least one optical element and by the optical element with the features of the independent claims. Advantageous embodiments which might be realized in an isolated fashion or in any arbitrary combinations are listed in the dependent claims as well as throughout the specification.

In a first aspect of the present invention, a method of fabricating at least one optical element, specifically at least one optical element for a spectrometer device, is disclosed.

The term “spectrometer device” as used herein is a broad term and is to be given its ordinary and customary meaning to a person of ordinary skill in the art and is not to be limited to a special or customized meaning. The term specifically may refer, without limitation, to a device capable of optically analyzing at least one sample, thereby generating at least one item of information on at least one spectral property of the sample. Specifically, the term may refer to a device which is capable of recording a signal intensity with respect to a corresponding wavelength of a spectrum or a partition thereof, such as a wavelength interval, wherein the signal intensity may, preferably, be provided as an electrical signal which may be used for further evaluation. At least one wavelength-selective element, such as an optical filter and/or a dispersive element, may be provided and may be used for separating incident light into a spectrum of constituent wavelength components whose respective intensities are determined by employing at least one detector element. In addition, further optical elements may be used which can be designed for receiving and/or transferring incident light. The one or more elements of the spectrometer device may be accommodated in a housing of the spectrometer device. The spectrometer device, generally, may be operable in a reflective mode and/or may be operable in a transmissive mode.

The term “optical element” as used herein is a broad term and is to be given its ordinary and customary meaning to a person of ordinary skill in the art and is not to be limited to a special or customized meaning. The term specifically may refer, without limitation, to an element or a combination of elements configured for interacting with light in a pre-defined manner. Thus, as an example, the optical element may be or may comprise at least one of: an optical sensing element; an optical emitting element, specifically a light source; a diffractive element, specifically a lens; an optical filter. Other optical elements are feasible.

As used herein, the term “light” may generally refer to a partition of electromagnetic radiation which is, usually, referred to as “optical spectral range” and which specifically comprises one or more of the visible spectral range, the ultraviolet spectral range and the infrared spectral range. The terms “ultraviolet spectral range” or “UV”, generally, refer to electromagnetic radiation having a wavelength of 1 nm to 380 nm, preferably of 100 nm to 380 nm. The term “visible spectral range”, generally, refers to a wavelength of 380 nm to 760 nm. The terms “infrared spectral range” or “IR”, generally, refer to a wavelength of 760 nm to 1000 μm, wherein a wavelength of 760 nm to 3 μm is, usually, denominated as “near infrared spectral range” or “NIR” while the wavelength of 3 μ to 15 μm is, usually, denoted as “mid infrared spectral range” or “MidIR” and the wavelength of 15 μm to 1000 μm as “far infrared spectral range” or “FIR”. Thus, when denoting an element as “optical”, the element may be configured for interacting with electromagnet radiation in the optical spectral range. The optical element may comprise a combination of multiple elements, wherein each of the elements may be configured for interacting with light in a pre-defined manner. The interaction with light may comprise one or more of refraction, diffraction, scattering, absorption, transmission, reflection, interference or the like. For example, the optical element may comprise a combination of at least one optical filter and at least one optical lens, as will be outlined in further detail below. The optical element may specifically be part of a spectrometer device as defined above.

The term “fabricating” as used herein is a broad term and is to be given its ordinary and customary meaning to a person of ordinary skill in the art and is not to be limited to a special or customized meaning. The term specifically may refer, without limitation, to a process of manufacturing objects. Fabricating may comprise one or more manufacturing steps in which the objects are created and/or produced. Specifically, fabricating may comprise one or more manufacturing steps in which one or more raw material may be transformed into final objects. Thus, in the case of fabricating the optical element, one or more manufacturing steps may be performed in which one or more raw material may be transformed into the optical element. The manufacturing steps may specifically be automated manufacturing steps being performed by or with the help of machines, tools and/or other equipment. Thus, the method of fabricating the optical element may comprise automatically fabricating the optical element, specifically without the need for manual manufacturing steps.

The method comprises the following steps which, as an example, may be performed in the given order. It shall be noted, however, that it is also possible to perform one or more of the method steps once or repeatedly. Further, it is possible to perform two or more of the method steps simultaneously or in a timely overlapping fashion. The method may comprise further method steps which are not listed.

The method comprises:
i. at least one preparation step, wherein the preparation step comprises providing at least one substrate having at least one first surface and at least one second surface, wherein the second surface is located opposite with respect to the first surface;
ii. at least one deposition step, wherein the deposition step comprises applying at least one first layer to the first surface of the substrate, wherein the first layer comprises at least one of an optical filter and an anti-reflection coating; and
iii. at least one molding step, wherein the molding step comprises molding at least one optical lens onto the first layer.

The term “preparation step” as used herein is a broad term and is to be given its ordinary and customary meaning to a person of ordinary skill in the art and is not to be limited to a special or customized meaning. The term specifically may refer, without limitation, to a manufacturing step comprising a provision of at least one object. The preparation step may comprise making the object to be provided available for further manufacturing steps. Specifically, in the preparation step, the substrate may be made available for further manufacturing steps. Therein, a commercially available substrate may be provided and/or the substrate or a part thereof may be produced.

The term “substrate” as used herein is a broad term and is to be given its ordinary and customary meaning to a person of ordinary skill in the art and is not to be limited to a special or customized meaning. The term specifically may refer, without limitation, to an arbitrary element configured for carrying one or more other elements disposed thereon or therein. In particular, the substrate may be a planar substrate. The substrate may have an elliptical shape, specifically a circular shape. The substrate specifically may be or may comprise a flat substrate, having two opposing surfaces, wherein the surfaces specifically may be essentially flat and/or wherein the surfaces specifically may be essentially parallel to each other. For example, the substrate may comprise a wafer, such as a wafer made of an insulating or semiconducting material. Alternatively, the substrate may have an elongated shape, such as a rectangular shape, a strip shape or a bar shape. However, other kinds of shapes or even irregular shapes, such as shapes comprising a combination of elliptic and/or rectangular shapes, may also be feasible. The substrate may provide a basis for further manufacturing steps, such as for adding further elements onto the substrate. For example, the substrate may be configured, such as by having appropriate surface properties in terms of roughness, cleanliness, smoothness, surface energy, moisture or the like, for depositing one or more layers onto the substrate.

The substrate specifically may be a transparent substrate. As used herein, the term “transparent” may generally refer to a property of the substrate of at least partially transmitting light in at least one partition of the optical spectral range, such as in one or more of the visible spectral range, the infrared spectral range and/or the ultraviolet spectral range. The transparent substrate may transmit light in at least one partition of the optical spectral range in the amount of at least 50%, specifically in the amount of at least 70%, more specifically in the amount of at least 90%, of an incident light intensity. The transparent substrate may comprise at least one transparent material. The transparent material may be selected from the group consisting of: glass; quartz; silicate; fused silica; soda-lime-silicate; borosilicate; silicon; a transparent conducting oxide, such as aluminum oxide, titanium oxide or indium tin oxide; a transparent organic polymer.

As outlined above, the substrate comprises the at least one first surface and the at least one second surface, wherein the second surface is located opposite with respect to the first surface. The term “surface” as used herein is a broad term and is to be given its ordinary and customary meaning to a person of ordinary skill in the art and is not to be limited to a special or customized meaning. The term specifically may refer, without limitation, to a boundary differentiating between two spatial regions occupied by different matter and/or by matter in different physical states. The surface of the substrate may differentiate between a spatial region forming the substrate itself and a spatial region of its surrounding. Specifically, the surface of the substrate may comprise an interface between the substrate and its surrounding, such as air, vacuum or other matter. The substrate may specifically be a planar substrate and, thus, may essentially have at least two surfaces, specifically the first surface and the second surface. As used in the context of the substrate's surfaces, the terms “first” and “second” are used for the purpose of nomenclature only, without ranking or numbering the surfaces or without giving any preferences. Further, this numbering does not refer to a specific number or order of items. The first surface and the second surface of the substrate may be spaced from each other by a distance of from 100 μm to 1 mm, specifically of from 250 μm to 700 μm. The spacing between the first surface and the second surface may refer to a vertical direction of the substrate, specifically a direction perpendicular to a lateral extension of the substrate's surface.

As further outlined above, the method comprises the at least one deposition step. The term “deposition step” as used herein is a broad term and is to be given its ordinary and customary meaning to a person of ordinary skill in the art and is not to be limited to a special or customized meaning. The term specifically may refer, without limitation, to a manufacturing step comprising an application of at least one layer to an object. In the deposition step, the at least one layer may be applied to the substrate, specifically to at least one of the first surface and the second surface of the substrate. Applying the at least one layer to the substrate may comprise generating the layer on one or more of the first surface and the second surface of the substrate. Specifically, the applying in the deposition step may comprise coating the substrate with the at least one layer.

The term “layer” as used herein is a broad term and is to be given its ordinary and customary meaning to a person of ordinary skill in the art and is not to be limited to a special or customized meaning. The term specifically may refer, without limitation, to an extended body having two sides exhibiting a lateral extension and a thickness by which the two sides are separated from each other, wherein the two sides of the layer may, preferably, be arranged in a parallel fashion with respect to each other. The lateral extension may exceed the thickness of the layer by a factor of at least 10, specifically by a factor of at least 100, more specifically by a factor of at least 1000. The layer may have a thickness of from 1 nm to 100 μm, specifically of from 10 nm to 10 μm, more specifically of from 100 nm to 1 μm. The layer may particularly have a thickness of 100 nm to 1 μm.

As used in the context of the layer, the terms “first” and “second” are used for the purpose of nomenclature only, without ranking or numbering the layers or without giving any preferences. Further, this numbering does not refer to a specific number or order of items. For example, it may be possible to apply one or more first layers and/or to apply one or more second layers. Further, the presence of one or more first layers may not necessarily imply a presence of one or more second layers. The at least one first layer may specifically refer to one or more layers applied to the first surface of the substrate. Similarly, at least one second layer may refer to one or more layers applied to the second surface of the substrate, as will be outlined in further detail below.

As outlined above, the first layer comprises at least one of an optical filter and an anti-reflection coating. For example, the first layer may comprise the at least one optical filter. The term “optical filter” as used herein is a broad term and is to be given its ordinary and customary meaning to a person of ordinary skill in the art and is not to be limited to a special or customized meaning. The term specifically may refer, without limitation, to an optical element configured for attenuating light, specifically in a wavelength-selective fashion, and/or for selectively transmitting light of different wavelengths. Specifically, the optical filter may be configured for transmitting an incident light beam, whereby a spectral composition may be modified upon transmission. For example, the optical filter may be configured for selectively transmitting light in a particular range of wavelengths, while absorbing and/or interfering the remainder. The optical filter may comprise at least one of an optical absorptive filter and an optical interference filter. For possible materials of the optical filter, reference may be made e.g. to WO 2018/077870 A1. Other options, however, are also feasible.

The optical filter may be configured for transmitting only wavelengths above a certain wavelength threshold, also denoted as “long pass filter”. The optical filter may be configured for transmitting only wavelength below a certain wavelength threshold, also denoted as “shortpass” filter”. The optical filter may be configured for transmitting wavelength only in certain wavelength intervals, also denoted as “band pass filter”. However, further optical filters may also be feasible. Specifically, the optical filter may be selected from the group consisting of: a band pass filter; a long pass filter; a short pass filter; a monochromatic filter; a linear variable filter; a polarization filter; a neutral density filter; a band rejection filter.

Alternatively or additionally, the first layer may comprise the at least one anti-reflection coating. The term “anti-reflection coating” as used herein is a broad term and is to be given its ordinary and customary meaning to a person of ordinary skill in the art and is not to be limited to a special or customized meaning. The term specifically may refer, without limitation, to an optical element configured for reducing reflection. Specifically, the anti-reflection coating may be configured for reducing reflection such that a fraction of power of reflected light compared to a total power of incident light is less than 5%, more specifically less than 1% or even less than 0.1%. The anti-reflection coating may be configured for reducing reflection in at least one wavelength range, specifically in at least one wavelength range in the optical spectral range. The antireflection coating may have a refractive index which is suitable for reducing reflection. For example, the anti-reflection coating may have a refractive index equal to a square root of the substrate's refractive index. However, other examples of anti-reflection coating, such as multilayer coatings having alternating refractive indices, are also feasible.

The method may further comprise:
iv. applying at least one second layer to the second surface of the substrate, wherein the second layer comprises at least one of an optical filter and an anti-reflection coating.

Specifically, step iv. may be performed after the deposition step. Alternatively or additionally, the second layer may be applied simultaneously or in a timely overlapping fashion to the first layer being applied to the first surface of the substrate in the deposition step. The second layer may comprise the at least one optical filter. The optical filter may comprise at least one of an optical absorptive filter and an optical interference filter. The optical filter may specifically be selected from the group consisting of: a band pass filter; a long pass filter; a short pass filter; a monochromatic filter; a linear variable filter; a polarization filter; a neutral density filter; a band rejection filter. The second layer, specifically the optical filter of the second layer, may be configured similar to the first layer, specifically to the optical filter of the first layer. However, a second layer, specifically the optical filter of the second layer, may also be different from the first layer, specifically from the optical filter of the first layer.

The first layer and the second layer may be configured according to any one of the following options:
the first layer comprises at least one optical filter, and the second layer comprises at least one anti-reflection coating;
the first layer comprises at least one optical filter, and the second layer also comprises at least one optical filter;
the first layer comprises at least one anti-reflection coating, and the second layer comprises at least one optical filter;
the first layer comprises at least one anti-reflection coating, and the second layer also comprises at least one anti-reflection coating.

As used herein, when referring to the first layer and/or the second layer comprising the optical filter and/or the anti-reflection coating, the first layer and the second layer may consist of the optical filter and/or the anti-reflection coating, respectively. However, as used in this context, the term “comprise” may not exclude the possibility that the first layer and the second layer consist of multiple layers.

The first layer and optionally the second layer may be applied to the first surface and optionally the second surface of the substrate, respectively, by using at least one deposition method. The deposition may take place, e.g., from the liquid phase and/or by using a vacuum deposition process. The deposition method specifically may be selected from the group consisting of: atomic layer deposition; chemical vapor deposition; plasma-enhanced chemical vapor deposition; chemical bath deposition; spin coating; dip coating; physical vapor deposition; molecular beam epitaxy; pulsed laser deposition.

As further outlined above, the method comprises the at least one molding step. The term “molding step” as used herein is a broad term and is to be given its ordinary and customary meaning to a person of ordinary skill in the art and is not to be limited to a special or customized meaning. The term specifically may refer, without limitation, to a manufacturing step comprising shaping at least one liquid or pliable material into at least one object by using at least one mold. The mold may specifically be a rigid and hollow form configured for inserting the liquid or pliable material to be molded. The mold may be configured for being heated and/or pressurized. Thus, the molding step may comprise heating the mold, specifically during injection of the liquid or pliable material into the mold. Further, the molding step may comprise pressurizing the mold when liquid or pliable material is inside the mold in order to shape the object to be molded. The molding step may specifically comprise a sequence of molding sub steps, also denoted as “molding process”, as will be outlined in further detail below. The molding step may use a single liquid or pliable material or a composition of liquid or pliable materials for the molding process. The object to be molded may specifically comprise an optical lens.

The term “optical lens” as used herein is a broad term and is to be given its ordinary and customary meaning to a person of ordinary skill in the art and is not to be limited to a special or customized meaning. The term specifically may refer, without limitation, to an optical element configured for focusing or dispersing an incident light beam. The optical lens may be configured for transmitting the incident light beam thereby providing at least one function of focusing or dispersing the incident light beam. The optical lens may be a simple lens made from a single piece and/or a compound lens comprising two or more simple lenses. The optical lens may comprise at least one transparent material, specifically at least one moldable transparent material, as will be outlined in further detail below. The optical lens may be molded onto the first layer in at least one of a concave form, a convex form, a free form and a Fresnel form. The optical lens has a thickness of from 200 μm to 5 mm. The optical lens may have a radius of from 200 μm to 3 mm. The optical lens may further comprise a baseline, for example a baseline due to injection molding. The baseline may have a thickness of from 20 μm to 500 μm.

The molding step may comprise liquefying at least one molding material. The liquefying may comprise heating the molding material in a heating cavity or the like. The molding material may be selected from the group consisting of: a plastic material; a thermoplastic material, specifically polycarbonate, acrylonitrile butadiene styrene and/or poly (methyl methacrylate); a thermoset material, specifically silicone and/or epoxy; a glass material, specifically fused silica.

Further, the molding step may comprise generating at least one mold in between the first layer and the at least one molding tool applied onto the first layer. The molding step may comprise introducing the liquefied molding material into the mold, specifically in a pressurized manner. The molding step may further comprise removing the molding tool.

The optical lens may specifically be molded onto the first layer by using at least one of injection molding and transfer molding, specifically film assisted molding. The molding step may specifically comprise at least one molding technique suitable for wafer-level molding.

The molding step may specifically comprise a molding process comprising a sequence of the following molding sub steps:
liquefying the at least one molding material;
generating at least one mold in between the first layer and the at least one molding tool applied onto the first layer;
introducing the liquefied molding material into the mold, specifically in a pressurized manner;
removing the molding tool.

However, further molding sub steps in the molding process may also be feasible.

Additionally or alternatively, the molding step may comprise molding at least one further optical lens onto the second layer. The molding of the further optical lens onto the second layer may specifically comprise a similar molding process as described when referring to molding the optical lens onto the first layer.

The molding step may further comprise molding a plurality of optical lenses onto the first layer to obtain a plurality of optical elements. The plurality of optical lenses may be molded in a pattern onto the first layer, for example in a rectangular matrix pattern, in a line pattern or the like. The method may further comprise:
v. at least one separation step, wherein the separation step comprises separating the plurality of optical elements.

The separating of the plurality of optical elements may comprise using at least one separation technique selected from the group consisting of: mechanical dicing, specifically saw dicing; laser dicing, specifically stealth dicing; reactive dicing, specifically plasma dicing; glass cutting, specifically scribe and break.

The method may specifically comprise in the preparation step providing at least one borosilicate wafer as the substrate. The substrate may be coated with one or more first layers and/or one or more second layers in the deposition step. Specifically, a thin film stack may be coated onto the substrates' surfaces. Further, a plurality of optical lenses may be molded in a pattern on top of the coated substrate in the molding step. After the molding step, the method may comprise the separation step comprising separating the plurality of optical lenses from each other by using saw dicing.

In a further aspect of the present invention, a system for fabricating at least one optical element, specifically at least one optical element for a spectrometer device, is disclosed. The term “system” as used herein is a broad term and is to be given its ordinary and customary meaning to a person of ordinary skill in the art and is not to be limited to a special or customized meaning. The term specifically may refer, without limitation, to an arbitrary set of interacting or interdependent components parts forming a whole. Specifically, the components may interact with each other in order to fulfill at least one common function. The at least two components may be handled independently or may be coupled or connectable.

The system comprises:
a. at least one deposition device configured for applying at least one first layer to at least one first surface of at least one substrate, the substrate having the at least one first surface and at least one second surface, wherein the second surface is located opposite with respect to the first surface, wherein the first layer comprises at least one of an optical filter and an anti-reflection coating; and
b. at least one molding device configured for molding at least one optical lens onto the first layer.

The term “deposition device” as used herein is a broad term and is to be given its ordinary and customary meaning to a person of ordinary skill in the art and is not to be limited to a special or customized meaning. The term specifically may refer, without limitation, to an arbitrary device configured for performing at least one deposition step as outlined above. Specifically, the deposition device may be configured for performing at least one deposition method. The deposition method may be selected from the group consisting of: atomic layer deposition; chemical vapor deposition; plasma-enhanced chemical vapor deposition; chemical bath deposition; spin coating; dip coating; physical vapor deposition; molecular beam epitaxy; pulsed laser deposition. The deposition device may be configured for applying at least one second layer to the second surface of the substrate. The second layer may comprise at least one of an optical filter and an anti-reflection coating.

The term “molding device” as used herein is a broad term and is to be given its ordinary and customary meaning to a person of ordinary skill in the art and is not to be limited to a special or customized meaning. The term specifically may refer, without limitation, to an arbitrary device configured for performing at least one molding step as outlined above. Specifically, the molding device may be configured for performing at least one of injection molding and transfer molding, specifically film assisted molding.

For further definitions and possible embodiments of the system, reference is made to the description of the method for fabricating at least one optical element as outlined above. The system may specifically be configured for performing the method for fabricating at least one optical element according to the present invention, such as according to any one of the embodiments disclosed above and/or according to any one of the embodiments disclosed in further detail below.

In a further aspect of the present invention, an optical element is disclosed. The optical element comprises at least one substrate having at least one first surface and at least one second surface. The second surface is located opposite with respect to the first surface. The optical element further comprises at least one first layer applied to the first surface of the substrate. The first layer comprises at least one of an optical filter and an anti-reflection coating. The optical element further comprises at least one optical lens molded onto the first layer.

The optical element may specifically be obtainable by the method according to the present invention, such as according to any one of the embodiments disclosed above and/or according to any one of the embodiments disclosed in further detail below. In particular, the optical element obtained by the method of fabricating at least one optical element may comprise no bracket or holder for connecting the optical lens with the first layer, specifically with the optical filter. Further, the optical element obtained by the method of fabricating at least one optical element may comprise no adhesive layer between the optical lens and the first layer, specifically the optical filter. In case of injection molding, the optical element, specifically the optical lens, may comprise a baseline on top of the first layer and below the optical lens due to the molding step.

For definitions and possible embodiments of the optical element, reference is made to the description of the method for fabricating at least one optical element as outlined above.

The method and the system according to the present invention may provide a large number of advantages over known methods and devices. Specifically, with the method and the system according to the present invention, it may be possible to fabricate optical elements comprising two optical components with different functions in one single compound. Additionally, molding, specifically wafer-level molding, may be a high volume process and, thus, may be easily scalable and furthermore a cost effective process. Further, the method and the system according to the present invention may provide means for integrating the optical lens and the first layer, specifically the optical filter, in an optical path and ensuring their correct alignment with respect to each other.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:

Embodiment 1: A method of fabricating at least one optical element, specifically at least one optical element for a spectrometer device, comprising:
i. at least one preparation step, wherein the preparation step comprises providing at least one substrate having at least one first surface and at least one second surface, wherein the second surface is located opposite with respect to the first surface;
ii. at least one deposition step, wherein the deposition step comprises applying at least one first layer to the first surface of the substrate, wherein the first layer comprises at least one of an optical filter and an anti-reflection coating; and
iii. at least one molding step, wherein the molding step comprises molding at least one optical lens onto the first layer.

Embodiment 2: The method according to the preceding embodiment, wherein the substrate is a transparent substrate.

Embodiment 3: The method according to the preceding embodiment, wherein the transparent substrate comprises at least one transparent material.

Embodiment 4: The method according to the preceding embodiment, wherein the transparent material is selected from the group consisting of: glass; quartz; silicate; fused silica; soda-lime-silicate; borosilicate; silicon; a transparent conducting oxide, such as aluminum oxide, titanium oxide or indium tin oxide; a transparent organic polymer.

Embodiment 5: The method according to any one of the preceding embodiments, wherein the first surface and the second surface of the substrate are spaced from each other by a distance of from 100 μm to 1 mm, specifically of from 250 μm to 700 μm.

Embodiment 6: The method according to any one of the preceding embodiments, wherein the first layer comprises at least one optical filter.

Embodiment 7: The method according to the preceding embodiment, wherein the optical filter comprises at least one of an optical absorptive filter and an optical interference filter.

Embodiment 8: The method according to any one of the two preceding embodiments, wherein the optical filter is selected from the group consisting of: a band pass filter; a long pass filter; a short pass filter; a monochromatic filter; a linear variable filter; a polarization filter; a neutral density filter; a band rejection filter.

Embodiment 9: The method according to any one of the preceding embodiments, wherein the first layer comprises at least one anti-reflection coating.

Embodiment 10: The method according to any one of the preceding embodiments, further comprising:
iv. applying at least one second layer to the second surface of the substrate, wherein the second layer comprises at least one of an optical filter and an anti-reflection coating.

Embodiment 11: The method according to the preceding embodiment, wherein the second layer comprises at least one optical filter.

Embodiment 12: The method according to the preceding embodiment, wherein the optical filter comprises at least one of an optical absorptive filter and an optical interference filter.

Embodiment 13: The method according to any one of the two preceding embodiments, wherein the optical filter is selected from the group consisting of: a band pass filter; a long pass filter; a short pass filter; a monochromatic filter; a linear variable filter; a polarization filter; a neutral density filter; a band rejection filter.

Embodiment 14: The method according to any one of the five preceding embodiments, wherein the first layer and the second layer are configured according to any one of the following options:
the first layer comprises at least one optical filter, and the second layer comprises at least one anti-reflection coating;
the first layer comprises at least one optical filter, and the second layer also comprises at least one optical filter;
the first layer comprises at least one anti-reflection coating, and the second layer comprises at least one optical filter;
the first layer comprises at least one anti-reflection coating, and the second layer also comprises at least one anti-reflection coating.

Embodiment 15: The method according to any one of the preceding embodiments, wherein the first layer and optionally the second layer are applied to the first surface and optionally the second surface of the substrate, respectively, by using at least one deposition method.

Embodiment 16: The method according to the preceding embodiment, wherein the deposition method is selected from the group consisting of: atomic layer deposition; chemical vapor deposition; plasma-enhanced chemical vapor deposition; chemical bath deposition; spin coating; dip coating; physical vapor deposition; molecular beam epitaxy; pulsed laser deposition.

Embodiment 17: The method according to any one of the preceding embodiments, wherein the molding step comprises liquefying at least one molding material.

Embodiment 18: The method according to the preceding embodiment, wherein the molding material is selected from the group consisting of: a plastic material; a thermoplastic material, specifically polycarbonate, acrylonitrile butadiene styrene and/or poly (methyl methacrylate); a thermoset material, specifically silicone and/or epoxy; a glass material, specifically fused silica.

Embodiment 19: The method according to any one of the two preceding embodiments, wherein the molding step comprises generating at least one mold in between the first layer and at least one molding tool applied onto the first layer.

Embodiment 20: The method according to the preceding embodiment, wherein the molding step comprises introducing the liquefied molding material into the mold, specifically in a pressurized manner.

Embodiment 21: The method according to the preceding embodiment, wherein the molding step comprises removing the molding tool.

Embodiment 22: The method according to any one of the preceding embodiments, wherein the optical lens is molded onto the first layer by using at least one of injection molding and transfer molding, specifically film assisted molding.

Embodiment 23: The method according to any one of the preceding embodiments, wherein the optical lens is molded onto the first layer in at least one of a concave form, a convex form, a free form and a Fresnel form.

Embodiment 24: The method according to any one of the preceding embodiments, wherein the optical lens has a thickness of from 200 μm to 5 mm.

Embodiment 25: The method according to any one of the preceding embodiments, wherein the optical lens has a radius of from 200 μm to 3 mm.

Embodiment 26: The method according to any one of the preceding embodiments, wherein the optical lens may comprise a baseline, wherein the baseline has a thickness of from 20 μm to 500 μm.

Embodiment 27: The method according to any one of the preceding embodiments, wherein the molding step comprises molding at least one further optical lens onto the second layer.

Embodiment 28: The method according to any one of the preceding embodiments, wherein the molding step comprises molding a plurality of optical lenses onto the first layer to obtain a plurality of optical elements.

Embodiment 29: The method according to the preceding embodiment, wherein the plurality of optical lenses is molded in a pattern onto the first layer.

Embodiment 30: The method according to any one of the two preceding embodiments, further comprising:
v. at least one separation step, wherein the separation step comprises separating the plurality of optical elements.

Embodiment 31: The method according to the preceding embodiment, wherein the separating of the plurality of optical elements comprises using at least one separation technique selected from the group consisting of: mechanical dicing, specifically saw dicing; laser dicing, specifically stealth dicing; reactive dicing, specifically plasma dicing; glass cutting, specifically scribe and break.

Embodiment 32: A system for fabricating at least one optical element, specifically at least one optical element for a spectrometer device, the system comprising:
a. at least one deposition device configured for applying at least one first layer to at least one first surface of at least one substrate, the substrate having the at least one first surface and at least one second surface, wherein the second surface is located opposite with respect to the first surface, wherein the first layer comprises at least one of an optical filter and an anti-reflection coating; and
b. at least one molding device configured for molding at least one optical lens onto the first layer.

Embodiment 33: The system according to the preceding embodiment, wherein the system is configured for perform the method of fabricating at least one optical element according to any one of the preceding embodiments referring to a method.

Embodiment 34: The system according to any one of the two preceding embodiments, wherein the deposition device is configured for performing at least one deposition method.

Embodiment 35: The system according to the preceding embodiment, wherein the deposition method is selected from the group consisting of: atomic layer deposition; chemical vapor deposition; plasma-enhanced chemical vapor deposition; chemical bath deposition; spin coating; dip coating; physical vapor deposition; molecular beam epitaxy; pulsed laser deposition.

Embodiment 36: The system according to any one of the four preceding embodiments, wherein the deposition device is configured for applying at least one second layer to the second surface of the substrate, wherein the second layer comprises at least one of an optical filter and an anti-reflection coating.

Embodiment 37: The system according to any one of the five preceding embodiments, wherein the molding device is configured for performing at least one of injection molding and transfer molding, specifically film assisted molding.

Embodiment 38: An optical element comprising at least one substrate having at least one first surface and at least one second surface, wherein the second surface is located opposite with respect to the first surface, further comprising at least one first layer applied to the first surface of the substrate, the first layer comprising at least one of an optical filter and an anti-reflection coating, the optical element further comprises at least one optical lens molded onto the first layer.

Embodiment 39: The optical element according to the preceding embodiment, wherein the optical element is obtainable by the method of fabricating at least one optical element according to any one of the preceding embodiments referring to a method.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows a flow chart of an embodiment of a method of fabricating at least one optical element;

FIG. 2 shows schematic illustrations of different steps of the method of FIG. 1;

FIGS. 3 to 4D show embodiments of an optical element in a schematic view; and

FIG. 5 shows an embodiment of a system for fabricating at least one optical element in a schematic view.

### DETAILED DESCRIPTION OF THE EMBODIMENTS

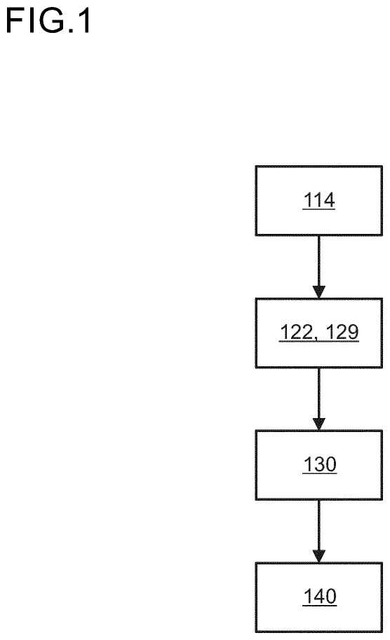

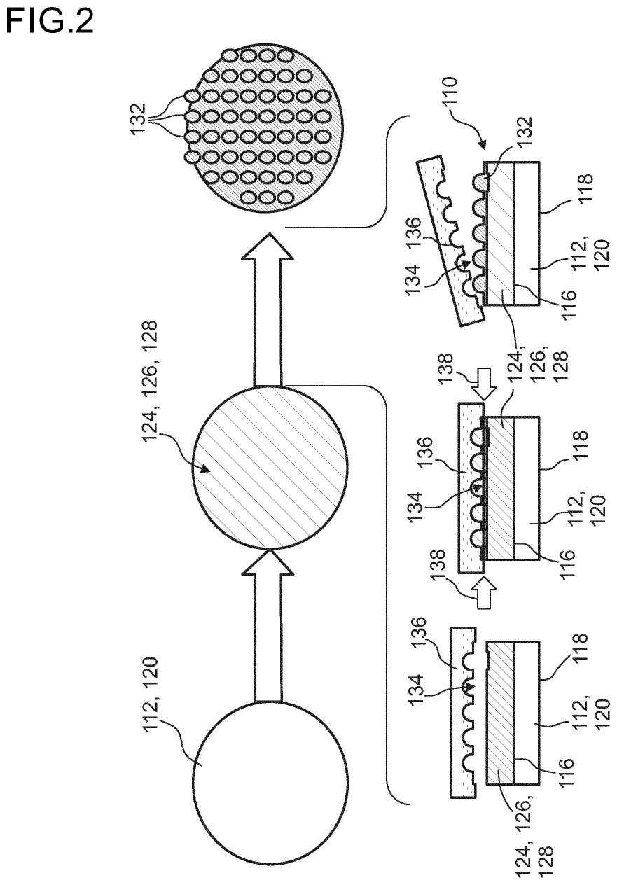

FIG. 1 shows a flow chart of an exemplary embodiment of a method for fabricating at least one optical element 110, specifically at least one optical element 110 for a spectrometer device (not shown in the Figures). In FIG. 2, different steps of the method shown in FIG. 1 are schematically illustrated. Thus, in the following, FIGS. 1 and 2 are described in conjunction. In the upper part of FIG. 2, a substrate 112 is shown in a top view, whereas in the lower part of FIG. 2, the substrate 112 is shown in a side view.

The method comprises at least one preparation step (denoted by reference number 114). The preparation step comprises providing the at least one substrate 112 having at least one first surface 116 and at least one second surface 118. The second surface 118 is located opposite with respect to the first surface 116. As shown in FIG. 2, the substrate 112 may comprise a wafer 120. The substrate 112 may specifically be a transparent substrate comprising at least one transparent material. For example, the substrate 112 may be a wafer 120 made from borosilicate. However, other transparent materials are also feasible.

The method further comprises at least one deposition step (denoted by reference number 122). The deposition step comprises applying at least one first layer 124 to the first surface 116 of the substrate 112. The first layer 124 comprises at least one of an optical filter 126 and an antireflection coating 128. The method may further comprise, specifically at least partially simultaneously to the deposition step, applying at least one second layer 127 to the second surface 118 of the substrate 112 (denoted by reference number 129). The second layer 127 comprises at least one of an optical filter 126 and an anti-reflection coating 128. The first layer 124, and optionally the second layer 127, may be applied to the first surface 116, and optionally the second surface 118 of the substrate 112, respectively, by using at least one deposition method. The deposition method may comprise a thin film deposition technique, such as atomic layer deposition, chemical vapor deposition, plasma-enhanced chemical vapor deposition, chemical bath deposition, spin coating, dip coating, physical vapor deposition, molecular beam epitaxy, pulsed laser deposition or the like.

Further, the method comprises at least one molding step (denoted by reference number 130). The molding step comprises molding at least one optical lens 132 onto the first layer 124. Thus, in this example, the optical element 110 may comprise a combination of the optical lens 132 on top of the first layer 124 comprising at least one of the optical filter 126 and the anti-reflection coating 128.

As can be seen in the lower part of FIG. 2, the molding step 130 may comprise a sequence of one or more molding sub steps. The molding step may comprise liquefying at least one molding material. The liquefying may comprise heating the molding material in a heating cavity or the like. The molding material may comprise a plastic material, a thermoplastic material and/or a glass material. Further, the molding step may comprise generating at least one mold 134 in between the first layer 124 and at least one molding tool 136 applied onto the first layer 124. The molding step may comprise introducing the liquefied molding material into the mold 134, specifically in a pressurized manner, as indicated by arrows 138 in FIG. 2. The molding step may further comprise removing the molding tool 136. The optical lens 132 may specifically be molded onto the first layer 124 by using at least one of injection molding and transfer molding, specifically film assisted molding. The molding step may specifically comprise at least one molding technique suitable for wafer-level molding.

As illustrated in FIG. 2, the molding step may comprise molding a plurality of optical lenses 132 onto the first layer 124 to obtain a plurality of optical elements 110. The plurality of optical lenses 132 may be molded in a pattern onto the first layer 124, for example in a rectangular matrix pattern. The method may further comprise at least one separation step (denoted by reference number 140). The separation step may comprise separating the plurality of optical elements 110. The separating of the plurality of optical elements 110 may comprise using at least one separation technique, such as mechanical dicing, laser dicing, reactive dicing, glass cutting or the like.

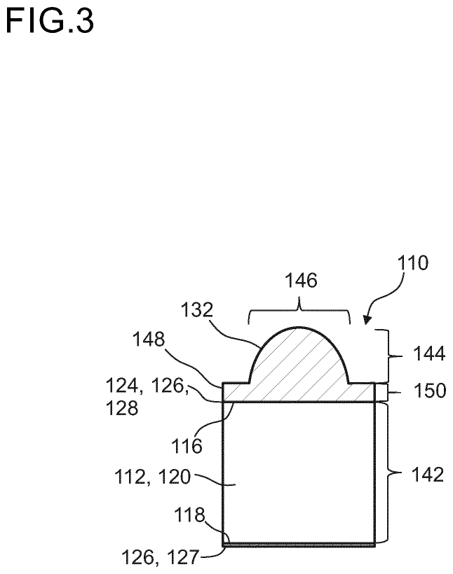

The result of the method as described in FIG. 1 can be seen in FIG. 3. Therein, an exemplary embodiment of the optical element 110 is shown in a schematic view. In this example, the first layer 124 may comprise the optical filter 126 and/or the anti-reflection coating 128. The second layer 127 may comprise the optical filter 126. The optical filter 126 may comprise at least one of an optical absorptive filter and an optical interference filter. Specifically, the optical filter 126 may comprise a band pass filter. Other optical filters, such as long pass filter, short pass filter, monochromatic filter, linear variable filter, polarization filter, neutral density filter, band rejection filter or the like, are also feasible. Further, also any other combination of the first layer 124 and the second layer 127 comprising at least one of the optical filter 126 and the antireflection coating 128 may also be possible.

As shown in FIG. 3, the first surface 116 and the second surface 118 of the substrate 112 may be spaced from each other by a distance 142 of from 100 μm to 1 mm, specifically of from 250 μm to 700 μm. The first layer 124 and the second layer 127 may have a thickness of from 1 nm to 100 μm, specifically of from 10 nm to 10 μm, more specifically of from 100 nm to 1 μm.

The optical lens 132 may have a thickness 144 of from 200 μm to 5 mm. The optical lens 132 may have a radius 146 of from 200 μm to 3 mm. The optical lens 132 may further comprise a baseline 148, for example a baseline due to injection molding. The baseline 148 may have a thickness 150 of from 20 μm to 500 μm.

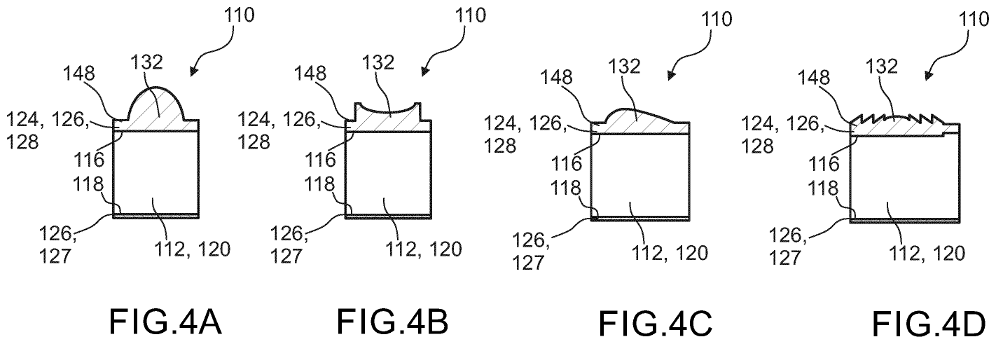

FIGS. 4A to 4D illustrates further exemplary embodiments of the optical element 110 as fabricated by performing the method shown in FIG. 1. The embodiments of the optical element 110 shown in FIGS. 4A to 4D may widely correspond to the embodiment of the optical element 110 shown in FIGS. 1 to 3. Thus, for a detailed description of the optical element 110, reference is made to the description of FIGS. 1 to 3. Further, in the molding step, the optical lens 132 may be molded onto the first layer 124 in a convex form (FIG. 4A), in a concave form (FIG. 4B), in a free form (FIG. 4C) and in a Fresnel form (FIG. 4D). However, other moldable forms of the optical lens 132 are also feasible.

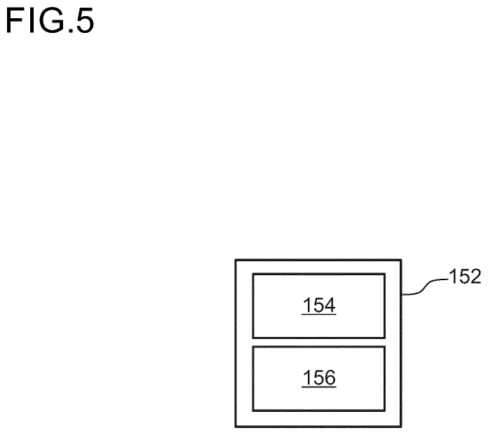

In FIG. 5, an exemplary embodiment of a system 152 for fabricating the at least one optical element 110 is shown in a schematic view. The system 152 comprises at least one deposition device 154 configured for applying the at least one first layer 124 to the at least one first surface 116 of the at least one substrate 112. The substrate 112 has the at least one first surface 116 and the at least one second surface 118. The second surface 118 is located opposite with respect to the first surface 116. The first layer 124 comprises at least one of the optical filter 126 and the anti-reflection coating 128. The deposition device 154 may be configured for performing at least one deposition method, specifically at least one deposition method selected from the group consisting of: atomic layer deposition; chemical vapor deposition; plasma-enhanced chemical vapor deposition; chemical bath deposition; spin coating; dip coating; physical vapor deposition; molecular beam epitaxy; pulsed laser deposition. The deposition device 154 may be configured for applying the at least one second layer 127 to the second surface 118 of the substrate 112. The second layer 127 may comprise at least one of the optical filter 126 and the antireflection coating 128.

The system 152 further comprises at least one molding device 156 configured for molding the at least one optical lens 132 onto the first layer 124. Specifically, the molding device 156 may be configured for performing at least one of injection molding and transfer molding, specifically film assisted molding.

The system 152 may be configured for performing the method for fabricating at least one optical element 110 according to the present invention, for example according to the exemplary embodiment disclosed in FIG. 1 and/or according to any other embodiment disclosed herein. The system 152 may specifically be configured for transferring the substrate 112 having at least the first layer 124 on the first surface 116 from the deposition device 154 to the molding device 156.

### LIST OF REFERENCE NUMBERS

110 optical element
112 substrate
114 preparation step
116 first surface
118 second surface
120 wafer
122 deposition step
124 first layer
126 optical filter
127 second layer
128 anti-reflection coating
129 applying at least one second layer
130 molding step
132 optical lens
134 mold
136 molding tool
138 arrows
140 separation step
142 distance of the first surface and the second surface
144 thickness of the optical lens
146 radius of the optical lens
148 baseline
150 thickness of the baseline
152 system
154 deposition device
156 molding device

1. A method of fabricating at least one optical element, comprising:
i. at least one preparation step, wherein the preparation step comprises providing at least one substrate having at least one first surface and at least one second surface, wherein the second surface is located opposite with respect to the first surface;
ii. at least one deposition step, wherein the deposition step comprises applying at least one first layer to the first surface of the substrate, wherein the first layer comprises at least one of an optical filter and an anti-reflection coating; and
iii. at least one molding step, wherein the molding step comprises molding at least one optical lens onto the first layer, wherein the optical lens is molded onto the first layer by using injection molding.

2. The method according to claim 1, wherein the substrate is a transparent substrate, wherein the transparent substrate comprises at least one transparent material, wherein the transparent material is selected from the group consisting of: glass; quartz; silicate; fused silica; soda-lime-silicate; borosilicate; silicon; a transparent conducting oxide; aluminum oxide; titanium oxide; indium tin oxide; and a transparent organic polymer.

3. The method according to claim 1, wherein the first layer comprises at least one optical filter, wherein the optical filter is selected from the group consisting of: a band pass filter; a long pass filter; a short pass filter; a monochromatic filter; a linear variable filter; a polarization filter; a neutral density filter; and a band rejection filter.

4. The method according to claim 1, further comprising:
iv. applying at least one second layer (to the second surface of the substrate, wherein the second layer comprises at least one of an optical filter and an anti-reflection coating.

5. The method according to claim 4, wherein the first layer and the second layer are configured according to any one of the following options:
the first layer comprises at least one optical filter, and the second layer comprises at least one anti-reflection coating;
the first layer comprises at least one optical filter, and the second layer also comprises at least one optical filter;
the first layer comprises at least one anti-reflection coating, and the second layer comprises at least one optical filter; and/or
the first layer comprises at least one anti-reflection coating, and the second layer also comprises at least one anti-reflection coating.

6. The method according to claim 1, wherein the first layer and optionally the second layer are applied to the first surface and optionally the second surface of the substrate, respectively, by using at least one deposition method, wherein the deposition method is selected from the group consisting of: atomic layer deposition; chemical vapor deposition; plasma-enhanced chemical vapor deposition; chemical bath deposition; spin coating; dip coating; physical vapor deposition; molecular beam epitaxy; and pulsed laser deposition.

7. The method according to claim 1, wherein the molding step comprises liquefying at least one molding material, wherein the molding material is selected from the group consisting of: a plastic material; a thermoplastic material; polycarbonate; acrylonitrile butadiene styrene; poly (methyl methacrylate); a thermoset material; silicone; epoxy; a glass material; and fused silica.

8. The method according to claim 7, wherein the molding step comprises generating at least one mold in between the first layer and at least one molding tool applied onto the first layer, wherein the molding step comprises introducing the liquefied molding material into the mold.

9. The method according to claim 1, wherein the optical lens is molded onto the first layer by using transfer molding.

10. The method according to claim 1, wherein the molding step comprises molding a plurality of optical lenses onto the first layer to obtain a plurality of optical elements.

11. The method according to claim 10, further comprising:
v. at least one separation step, wherein the separation step comprises separating the plurality of optical elements, wherein the separating of the plurality of optical elements comprises using at least one separation technique selected from the group consisting of: mechanical dicing; saw dicing; laser dicing; stealth dicing; reactive dicing; plasma dicing; glass cutting; and scribe and break.

12. A system for fabricating at least one optical element, the system comprising:
a. at least one deposition device configured for applying at least one first layer to at least one first surface of at least one substrate, the substrate having the at least one first surface and at least one second surface, wherein the second surface is located opposite with respect to the first surface, wherein the first layer comprises at least one of an optical filter and an anti-reflection coating and
b. at least one molding device configured for molding at least one optical lens onto the first layer.

13. The system according to claim 12, wherein the system is configured for performing a method of fabricating at least one optical element.

14. An optical element comprising at least one substrate having at least one first surface and at least one second surface, wherein the second surface is located opposite with respect to the first surface, further comprising at least one first layer applied to the first surface of the substrate, the first layer comprising at least one of an optical filter and an antireflection coating, and the optical element further comprises at least one optical lens molded onto the first layer.

15. The optical element according to claim 14, wherein the optical element is obtained by a method of fabricating at least one optical element.
